(19) United States
(12) Patent Application Publication
(10) Pub. No.: US 2025/0011952 A1
(43) Pub. Date: Jan. 9, 2025

(54) Semiconductor Photoelectrode

(71) Applicant: Nippon Telegraph and Telephone Corporation, Tokyo (JP)

(72) Inventors: Yuya Uzumaki, Musashino-shi, Tokyo (JP); Sayumi Sato, Musashino-shi, Tokyo (JP); Akihiro Kono, Musashino-shi, Tokyo (JP); Takeshi Komatsu, Musashino-shi, Tokyo (JP)

(21) Appl. No.: 18/709,757

(22) PCT Filed: Nov. 16, 2021
(86) PCT No.: PCT/JP2021/042036

§ 371 Date: May 13, 2024

(51) Int. Cl. C25B 11/02; C25B 11/052; C25B 11/087

(52) U.S. Cl. CPC C25B 11/02; C25B 11/052; C25B 11/087

(57) ABSTRACT

A semiconductor photoelectrode includes a conductive or insulating substrate having a moth-eye structure on a surface; a semiconductor thin film disposed on a surface having the moth-eye structure of the substrate; a catalyst layer disposed on the semiconductor thin film; and a reflection layer disposed on a surface opposite to the surface having the moth-eye structure of the substrate.

### TECHNICAL FIELD

The present invention relates to a semiconductor photoelectrode.

### BACKGROUND ART

A device that generates hydrogen by a decomposition reaction of water using the semiconductor photoelectrode has an oxidation tank and a reduction tank connected via a proton exchange membrane, an aqueous solution and an oxidation electrode are put in the oxidation tank, and the aqueous solution and the reduction electrode are put in the reduction tank. The oxidation electrode and the reduction electrode are electrically connected by a conductive wire.

The decomposition reaction of water using a photocatalyst is made up of an oxidation reaction of water and a reduction reaction of protons. When an n-type photocatalyst material is irradiated with light, electrons and holes are generated and separated in the photocatalyst. The holes move to a surface of the photocatalytic material and contribute to the reduction reaction of protons. On the other hand, the electrons move to the reduction electrode and contribute to the reduction reaction of protons. Ideally, such an oxidation-reduction reaction proceeds and a water decomposition reaction occurs.

2H₂O+4h⁺→O₂+4H⁺ Oxidation reaction:

4H⁺+4e⁻→2H₂ Reduction reaction:

### CITATION LIST

### Non Patent Literature

[NPL 1] S. Yotsuhashi, et al., “CO2 Conversion with Light and Water by GaN Photoelectrode”, Japanese Journal of Applied Physics, The Japan Society of Applied Physics, 2012, Volume 51, pp. 02BP07-1-02BP07-3
[NPL 2] “MPSS”, [online], El-Seed Corp., Internet <URL: http://elseed.com/products/mpss/>

### SUMMARY OF INVENTION

### Technical Problem

An amount of oxygen generation reaction on the surface of the semiconductor photoelectrode depends on the number of holes generated in the semiconductor. Therefore, it is important to increase the number of holes generated in the semiconductor, that is, to maximize the light absorbed by the semiconductor as much as possible for the improvement of efficiency. When a semiconductor thin film is irradiated with light, about 30% of light passes through the semiconductor thin film even in a wavelength region which can be absorbed with respect to the physical properties thereof. If the transmitted 30% of light can be reused, the light energy conversion efficiency can be improved. Therefore, a structure has been proposed in which a reflection layer is provided on a back surface of the semiconductor thin film to reflect transmitted light and absorb it again by the semiconductor thin film.

However, there was a problem in that the transmitted light was scattered within a bulk, and most of the light is absorbed in the bulk before it reaches the semiconductor thin film, and the reflected light cannot be efficiently utilized.

The present invention has been made in view of the above, and an object thereof is to improve a light energy conversion efficiency of a semiconductor photoelectrode.

### Solution to Problem

A semiconductor photoelectrode according to an embodiment of the present invention includes a conductive or insulating substrate having a moth-eye structure on a surface; a semiconductor thin film disposed on a surface having the moth-eye structure of the substrate; a catalyst layer disposed on the semiconductor thin film; and a reflection layer disposed on a surface opposite to the surface having the moth-eye structure of the substrate.

### Advantageous Effects of Invention

According to the present invention, it is possible to improve the light energy conversion y of efficiency the semiconductor photoelectrode.

### BRIEF DESCRIPTION OF DRAWINGS

FIG. 1 is a cross-sectional view showing an example of a configuration of a semiconductor photoelectrode of the present embodiment.

FIG. 2 is a cross-sectional view showing an example of the configuration of the semiconductor photoelectrode of the present embodiment.

FIG. 3 is a flowchart showing an example of a method for manufacturing the semiconductor photoelectrode of FIG. 1.

FIG. 4 is a flowchart showing an example of the method for manufacturing the semiconductor photoelectrode of FIG. 2.

FIG. 5 is a diagram showing a summary of a device for performing an oxidation-reduction reaction test.

FIG. 6 is a diagram for explaining how the diffusion of light passing through a moth-eye structure of the semiconductor photoelectrode of the present embodiment is controlled to be in one direction.

FIG. 7 is a view for explaining a state in which light incident on a conventional semiconductor photoelectrode is scattered in a substrate.

### DESCRIPTION OF EMBODIMENTS

An embodiment of the present invention will be described below with reference to the drawings. The present invention is not limited to the following embodiment, and may be modified without departing from the spirit of the present invention.

### Configuration of Semiconductor Photoelectrode

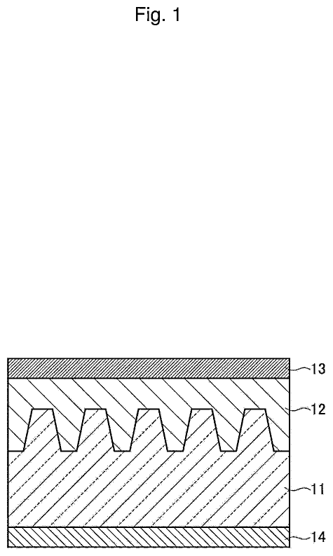

FIG. 1 is a cross-sectional view showing an example of a configuration of a semiconductor photoelectrode of the present embodiment. The semiconductor photoelectrode shown in FIG. 1 includes an insulating or conductive substrate 11 having a moth-eye structure on a surface, a semiconductor thin film 12 disposed on the moth-eye structure surface of the substrate 11, a catalyst layer 13 disposed on the semiconductor thin film 12, and a reflection layer 14 disposed on a lower surface of the substrate 11 opposite to the moth-eye structure surface.

As the substrate 11, an insulating or conductive substrate in which the moth-eye structure is formed on one side, such as a sapphire substrate, a GaN substrate, a glass substrate or a Si substrate can be used. The moth-eye structure is a structure that transmits the incident light in a vertical direction by a diffraction effect. For example, one described in NPL 2 can be used as the substrate 11.

Gallium nitride (GaN), aluminum gallium nitride (AlGaN) or indium gallium nitride (InGaN) is used for the semiconductor thin film 12. Or, a metal oxide such as titanium oxide (TiO₂) and tungsten oxide (WO₃) having a photocatalytic function, or a compound semiconductor such as tantalum nitride (Ta₃N₅) and cadmium sulfide (CdS) may be used for the semiconductor thin film 12.

One or more kinds of metals selected from Ni, Co, Cu, W, Ta, Pd, Ru, Fe, Zn, and Nb, or oxides made of metals may be used for the catalyst layer 13. A film thickness of the catalyst layer 13 is preferably 1 nm to 10 nm, particularly 1 nm to 3 nm which allows light to sufficiently pass through. The catalyst layer 13 may cover only a part of the surface of the semiconductor thin film 12.

For example, aluminum is used for the reflection layer 14. A metal having a high light reflectance can be used for the reflection layer 14.

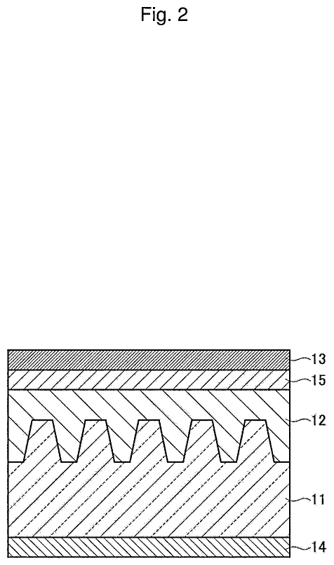

As shown in FIG. 2, a second semiconductor thin film 15 may be provided between the semiconductor thin film 12 and the catalyst layer 13. That is, the semiconductor photoelectrode of FIG. 2 includes the catalyst layer 13 on the second semiconductor thin film 15. The catalyst layer 13 may cover only a part of the surface of the second semiconductor thin film 15.

### Method for Manufacturing Semiconductor Photoelectrode

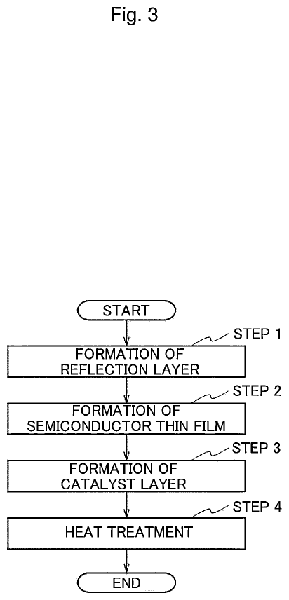

An example of the method for manufacturing the semiconductor photoelectrode of FIG. 1 will be described with reference to FIG. 3.

In step 1, the reflection layer 14 is formed on the back surface (flat surface opposite to the moth-eye structure surface) of the substrate 11. The reflection layer 14 may be formed by vacuum-depositing a metal constituting the reflection layer 14 on the back surface of the substrate 11.

In step 2, the semiconductor thin film 12 is formed on the moth-eye structure surface of the insulating or conductive substrate 11. The semiconductor thin film 12 may be formed, using an organic metal vapor deposition (MOCVD) method.

In step 3, a metal layer to be a base of the catalyst layer 13 is formed on the semiconductor thin film 12. The metal layer may be formed by vacuum-depositing a metal on the surface of the semiconductor thin film 12.

In step 4, the semiconductor thin film on which the metal layer is formed is heat-treated.

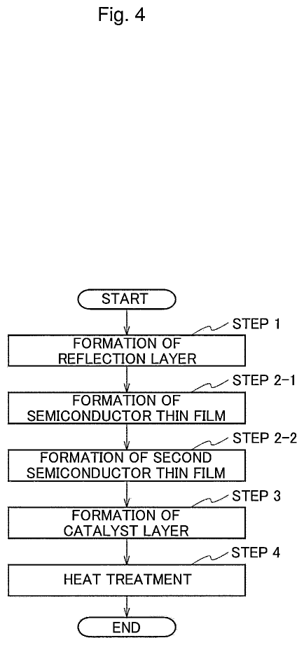

An example of the method for manufacturing the semiconductor photoelectrode of FIG. 2 will be described with reference to FIG. 4. In the method for manufacturing the semiconductor photoelectrode of FIG. 4, a step of forming the second semiconductor thin film is added to the method for manufacturing the semiconductor photoelectrode of FIG. 3.

In the step 1, the reflection layer 14 is formed on the back surface of the substrate 11.

In step 2-1, the semiconductor thin film 12 is formed on the moth-eye structure surface of the insulating or conductive substrate 11.

In step 2-2, the second semiconductor thin film 15 is formed on the semiconductor thin film 12. The second semiconductor thin film 15 may be formed using a MOCVD method.

In step 3, a metal layer to be the base of the catalyst layer 13 is formed on the semiconductor thin film 12.

In step 4, the semiconductor thin film on which the metal layer is formed is heat-treated.

### MANUFACTURING OF EXAMPLES AND COMPARATIVE EXAMPLES

Examples 1 to 3 in which the semiconductor photoelectrode of the present embodiment was produced will be described below. Comparative examples 1 to 3 using a substrate having no moth-eye structure will be described.

### Example 1

The semiconductor photoelectrode of Example 1 was manufactured using the manufacturing method shown in FIG. 3.

In step 1, metal Al was vacuum-deposited as the reflection layer 14 on the back surface of a sapphire substrate having a moth-eye structure on the surface.

In step 2, an n-GaN semiconductor thin film was epitaxially grown on the moth-eye structure surface of the sapphire substrate by the MOCVD method. Ammonia gas and trimethyl gallium were used as the growth raw materials, and hydrogen was used as the carrier gas sent into the growth reactor. Si was used as the dopant element. A film thickness of n-GaN was set to 2 μm. The carrier density was 3×10¹⁸ cm⁻³.

In step 3, Ni having a thickness of about 1 nm was vacuum-deposited on the n-GaN semiconductor thin film.

In step 4, the semiconductor thin film on which the Ni layer was formed was heat-treated in air for 1 hour at 300° C. to form an NiO layer. The film thickness of NiO was 2 nm when the sample cross section was TEM-observed.

The semiconductor photoelectrode of Example 1 was obtained by the above steps.

### Example 2

The semiconductor photoelectrode of Example 2 was manufactured, using the manufacturing method shown in FIG. 4.

In step 1, metal Al was vacuum-deposited as the reflection layer 14 on the back surface of the sapphire substrate having a moth-eye structure on the surface.

In step 2-1, an n-GaN semiconductor thin film was epitaxially grown on the moth-eye structure surface of the sapphire substrate, by a MOCVD method. Ammonia gas and trimethyl gallium were used as the growth raw material, and hydrogen was used as the carrier gas sent into the growth reactor. Si was used as the dopant element. A film thickness of n-GaN was set to 2 μm. The carrier density was 3×10¹⁸ cm⁻³.

In step 2-2, an Al_{0.1}Ga_{0.9}N semiconductor thin film was epitaxially grown on an n-GaN semiconductor thin film by the MOCVD method. Ammonia gas, trimethyl gallium, and trimethyl aluminum were used as the growth raw material, and hydrogen was used as the carrier gas sent into the growth reactor.

In step 3, Ni having a thickness of about 1 nm was vacuum-deposited on the AlGaN semiconductor thin film.

In step 4, a semiconductor thin film having a Ni layer formed thereon was heat-treated in the air at 300° C. for 1 hour to form a NiO layer. The film thickness of NiO was 2 nm when the sample cross section was TEM-observed.

The semiconductor photoelectrode of Example 2 was obtained through the above steps.

### Example 3

The semiconductor photoelectrode of Example 3 was manufactured, using the manufacturing method shown in FIG. 4. The material of the second semiconductor thin film 15 is different from Example 2.

In step 1, metal Al was vacuum-deposited as the reflection layer 14 on the back surface of a sapphire substrate having a moth-eye structure on the surface.

In step 2-1, an n-GaN semiconductor thin film was epitaxially grown on the moth-eye structure surface of the sapphire substrate, by a MOCVD method. Ammonia gas and trimethyl gallium were used as the growth raw material, and hydrogen was used as the carrier gas sent into the growth reactor. Si was used as the dopant element. A film thickness of n-GaN was set to 2 μm. The carrier density was 3×10¹⁸ cm⁻³.

In step 2-2, an Al_{0.05}Ga_{0.95}N semiconductor thin film was epitaxially grown on an n-GaN semiconductor thin film by the MOCVD method. Ammonia gas, trimethyl gallium, and trimethyl indium were used as the growth raw material, and hydrogen was used as the carrier gas sent into the growth reactor.

In step 3, Ni having a thickness of about 1 nm was vacuum-deposited on the InGaN semiconductor thin film.

In step 4, the semiconductor thin film having the Ni layer formed thereon was heat-treated in air at 300° C. for 1 hour to form a NiO layer. The film thickness of NiO was 2 nm when the sample cross section was TEM-observed.

The semiconductor photoelectrode of Example 3 was obtained by the above steps.

### Comparative Example 1

The semiconductor photoelectrode of Comparative Example 1 differs from Example 1 in that a flat sapphire substrate having no moth-eye structure is used.

In step 1, a metal Al was vacuum-deposited on one surface of the sapphire substrate, and in step 2, an n-GaN semiconductor thin film was epitaxially grown on the other surface of the sapphire substrate by the MOCVD method. Other points are the same as in Example 1.

### Comparative Example 2

The semiconductor photoelectrode of Comparative Example 2 differs from Example 2 in that a flat sapphire substrate having no moth-eye structure is used.

In step 1, a metal Al was vacuum-deposited on one surface of the sapphire substrate, and in step 2, an n-GaN semiconductor thin film was epitaxially grown on the other surface of the sapphire substrate by the MOCVD method. Other points are the same as in Example 2.

### Comparative Example 3

The semiconductor photoelectrode of Comparative Example 3 differs from Example 3 in that a flat sapphire substrate having no moth-eye structure is used.

In step 1, a metal Al was vacuum-deposited on one surface of the sapphire substrate, and in step 2, an n-GaN semiconductor thin film was epitaxially grown on the other surface of the sapphire substrate by the MOCVD method. Other points are the same as in Example 3.

### Oxidation/Reduction Reaction Test

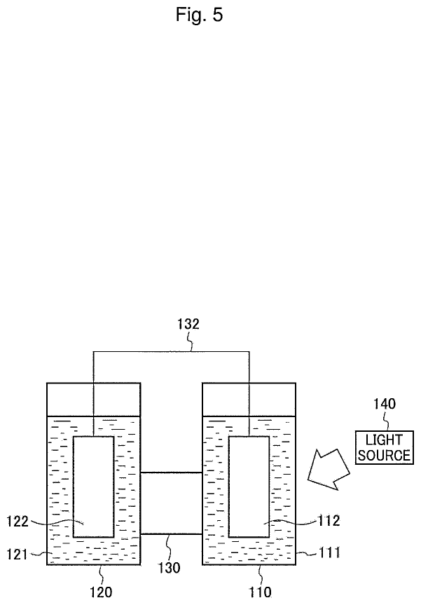

An oxidation-reduction reaction test was conducted using the device shown in FIG. 5 for Examples 1 to 3 and Comparative Examples 1 to 3.

The device shown in FIG. 5 includes an oxidation tank 110 and a reduction tank 120. An aqueous solution 111 is put in the oxidation tank 110, and an oxidation electrode 112 is put in the aqueous solution 111. An aqueous solution 121 is put in the reduction tank 120, and a reduction electrode 122 is put in the aqueous solution 121.

A 1 mol/l sodium hydroxide aqueous solution was used as the aqueous solution 111 in the oxidation tank 110. As the aqueous solution 111, a potassium hydroxide aqueous solution or hydrochloric acid may be used.

As the oxidation electrode 112, a semiconductor photoelectrode to be tested was used. Specifically, for each of Examples 1 to 3 and Comparative Examples 1 to 3, an electrode in which the n-GaN surface was scribed, a conductive wire was connected to a part of the surface, soldering was performed using indium, and covering was provided with an epoxy resin so as not to be exposed, was installed as the oxidation electrode 112.

A 0.5 mol/l potassium hydrogen carbonate aqueous solution was used for the aqueous solution 121 in the reduction tank 120. As the aqueous solution 121, a sodium bicarbonate aqueous solution, a potassium chloride aqueous solution, or a sodium chloride aqueous solution may be used.

As the reduction electrode 122, platinum (manufactured by Nilaco Corporation) was used. The reduction electrode 122 may be a metal or a metal compound. As the reduction electrode 122, for example, nickel, iron, gold, copper, indium, or titanium may be used.

The oxidation tank 110 and the reduction tank 120 are connected through a proton film 130. Protons generated in the oxidation tank 110 diffuse into the reduction tank 120 through the proton film 130. Nafion (registered trademark) was used for the proton film 130. Nafion is a perfluorocarbon material made of a hydrophobic Teflon skeleton made of carbon-fluorine and a perfluoro side chain having a sulfonic acid group.

The oxidation electrode 112 and the reduction electrode 122 are electrically connected by a conductive wire 132, and electrons move from the oxidation electrode 112 to the reduction electrode 122.

A 300 W high pressure xenon lamp (illuminance 5 mW/cm²) was used as a light source 140. The light source 140 may be able to emit light having a wavelength that can be absorbed by a material constituting a semiconductor photoelectrode installed as the oxidation electrode 112. For example, when the oxidation electrode 112 is made of gallium nitride, wavelength that can be absorbed by the oxidation electrode 112 is a wavelength of 365 nm or less. As the light source 140, light sources such as a xenon lamp, a mercury lamp, a halogen lamp, a pseudo sunlight source, or sunlight may be used, or these light sources may be combined.

In the oxidation-reduction reaction test, nitrogen gas was made to flow at 10 ml/min in each reaction tank, a sample area was set to 1 cm², and the aqueous solutions 111 and 121 were stirred at a center position of the bottom of each reaction tank at a rotational speed of 250 rpm using an agitator and a stirrer.

After the reaction tank was sufficiently replaced with nitrogen gas, the light source 140 was fixed to face the surface of the semiconductor photoelectrode to be tested installed as the oxidation electrode 112 on NiO was which formed, and the semiconductor photoelectrode was irradiated uniformly with light.

After 1 hours of light irradiation, the gas in each reaction tank was collected and the reaction product was analyzed by a gas chromatograph. As a result, it was confirmed that oxygen was generated in the oxidation tank 110 and hydrogen was generated in the reduction tank 120.

In the examples, although hydrogen was used as the target product, the production of carbon compounds by the reduction reaction of carbon dioxide, or the production of ammonia by the reduction reaction of nitrogen is also possible, by changing the metal of the reduction electrode (for example, Ni, Fe, Au, Pt, Ag, Cu, In, Ti, Co and Ru), or the atmosphere in the cell.

### Test Results

Table 1 shows the amount of oxygen/hydrogen gas generated after one hour of light irradiation in Examples 1 to 3 and Comparative Examples 1 to 3. The amount of each gas generated was shown by being normalized by the surface area of the semiconductor photoelectrode. In every example, it could be seen that oxygen and hydrogen are generated at the time of light irradiation.

TABLE 1

| | | | | Amount of gas generated | |
|---|---|---|---|---|---|
| | | | Second | in cell/μmol · h⁻¹ | |
| | Surface of | Semiconductor | semiconductor | 1 hour after light irradiation | |
| | substrate | thin film | thin film | Enzyme | Hydrogen |
| Example 1 | Moth-eye | n-GaN | Non | 14 | 28 |
| Example 2 | Moth-eye | n-GaN | AlGaN | 20 | 40 |
| Example 3 | Moth-eye | n-GaN | InGaN | 44 | 88 |
| Comparative Example 1 | Flat | n-GaN | Non | 11 | 22 |
| Comparative Example 2 | Flat | n-GaN | AlGaN | 15 | 30 |
| Comparative Example 3 | Flat | n-GaN | InGaN | 32 | 64 |

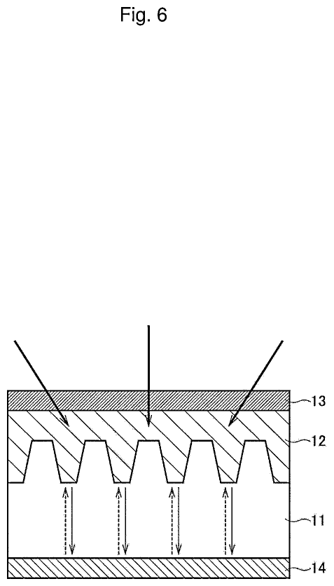

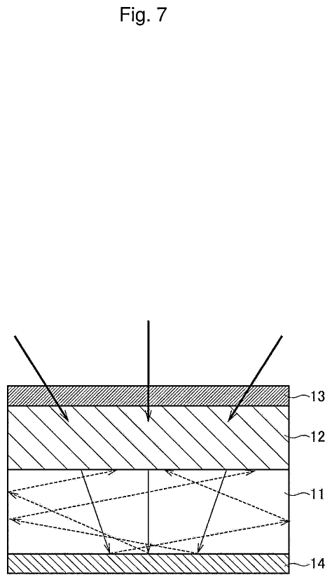

When Example 1 and Comparative Example 1 were compared, an amount of generation 1 hour after light irradiation was approximately 1.3 times. It is because, as shown in FIG. 6, the diffusivity of the light passing through the moth-eye structure is controlled in one direction (vertical direction), the light absorption in the substrate is suppressed, and the light can be reflected to the semiconductor thin film at the maximum. On the other hand, in Comparative Example 1, as shown in FIG. 7, light passing through the semiconductor thin film is scattered within the substrate, and most of the light reflected by the reflection layer is absorbed within the substrate before reaching the semiconductor thin film, and it is not possible to use the reflected light efficiently.

The same applies to the comparison between Examples 2 and 3 and Comparative Examples 2 and 3.

As described above, the semiconductor photoelectrode of the present embodiment includes the conductive or insulating substrate 11 having a moth-eye structure on its surface, the semiconductor thin film 12 disposed on the surface of the substrate 11 having the moth-eye structure, the catalyst layer 13 disposed on the semiconductor thin film 12, and the reflection layer 14 disposed on the back surface of the substrate 11 opposite to the surface having the moth-eye structure. By forming the semiconductor thin film and the catalyst layer on the substrate having the moth-eye structure on the surface and forming the reflection layer on the back surface, the diffusivity of irradiation light is controlled in the vertical direction, and light absorption in the substrate can be suppressed. Accordingly, light energy conversion efficiency of the semiconductor photoelectrode can be improved.

### REFERENCE SIGNS LIST

11 Substrate
12 Semiconductor thin film
13 Catalyst layer
14 Reflection layer
15 Semiconductor thin film

1. A semiconductor photoelectrode comprising:
a conductive or insulating substrate having a moth-eye structure on a surface;
a semiconductor thin film disposed on a surface having the moth-eye structure of the substrate;
a catalyst layer disposed on the semiconductor thin film; and
a reflection layer disposed on a surface opposite to the surface having the moth-eye structure of the substrate.

2. The semiconductor photoelectrode according to claim 1, further comprising:
a second semiconductor thin film disposed between the semiconductor thin film and the catalyst layer.

3. The semiconductor photoelectrode according to claim 1,
wherein the semiconductor thin film is an n-type semiconductor.

4. The semiconductor photoelectrode according to claim 2,
wherein the semiconductor thin film is an n-type semiconductor.
